(19) United States
(12) Patent Application Publication
(10) Pub. No.: US 2003/0037243 A1
(43) Pub. Date: Feb. 20, 2003

(54) Method and system for managing the presentation of information

(75) Inventors: Marco O. Gruteser, Yorktown Heights, NY (US); Anthony Levas, Yorktown Heights, NY (US); Paul Andrew Moskowitz, Yorktown Height, NY (US); Danny Chan Yong Wong, Allendale, NJ (US); Sachhiko Yoshihama, White Plains, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY

(21) Appl. No.: 09/928,428

(22) Filed: Aug. 14, 2001

(51) Int. Cl. H04L 9/00

(52) U.S. Cl. 713/185; 380/270

(57) ABSTRACT

A method (and system) includes receiving a request to present information selected from a plurality of examples of information, reading an identification token of at least one user, and determining whether the at least one user is authorized to be presented the information.

### BACKGROUND OF THE INVENTION

1. Field of the Invention

The present invention generally relates to a method (and system) for managing the presentation of information to assure the confidentiality of the information, and more particularly to a method (and system) for controlling a computer user interface for security purposes.

2. Description of the Related Art

Computing system user interfaces are capable of presenting a large range and quantity of information to a user. The information may take the form of a document to be displayed (e.g., by a text processing application), the information may be a notification (e.g., “New e-mail has arrived for you.”), the information may be an application (e.g., an image processing program), etc.

Many such instances of information display are private or confidential in that they are directed at, or for the use of, an individual or a selected set of individuals. For instance, a license to use a specific computing application may be associated with an individual or a set of individuals.

Some exemplary efforts have been made to safeguard the privacy of information presented by computing systems by allowing one user access to data while denying access to another user. For instance, mechanical screening of computer display screens has been taught by U.S. Pat. No. 5,963,371, to Needham et al., entitled “Method of displaying private data to collocated users”, and by U.S. Pat. No. 5,528,319, to Austin, entitled “Privacy filter for a display device”, each incorporated herein by reference. The devices described in these two patents allow one user to view the entire contents of a display screen while shielding the entire display from another user.

Electronic means have also been employed for the protection of information that may be presented by computing devices. These means are taught by U.S. Pat. No. 5,712,973, to Dayan et al., entitled “Wireless proximity containment security”, and by U.S. Pat. No. 6,070,340, to Xydis, entitled “Computer access control”, both herein incorporated by reference. The wireless devices described by Dayan and Xydis are used as keys to determine whether an individual user is authorized to operate a computing system. If the user is not authorized, then use of the system is denied.

However, in the case of computing systems that may be accessed or observed by more than one person, it is inconvenient to force the shutdown of an entire system or to deny the use of the system to a particular user because that user is not authorized to have access to some of the information that may be presented by the computing system.

That is, it is desirable to present individual examples of information or not according to the access permitted to a user to an individual example of information. It is also inconvenient to require the typing of passwords into a computing system by a user to obtain each example of information contained within the system. It is also inconvenient to fit computing system displays or user interfaces with mechanical screening devices.

Thus, the conventional systems and methods have been problematic.

### SUMMARY OF THE INVENTION

In view of the foregoing and other problems, drawbacks, and disadvantages of the conventional methods and structures, an object of the present invention is to provide a system, method, and computer program for managing the display of information by a computing system.

Further, it is an object of the invention to present information (e.g., files, notifications, and applications) to one or more users on a case-by-case basis for each example of information selectively, without denying access to an entire computing system.

Yet another object of the present invention is to suppress the presentation of individual examples of information in a dynamic manner based upon the composition of the group of users in the area of the computing system.

It is a further object of the present invention to allow the placement of examples of information (e.g., computer application programs) in a distributed manner on a multiplicity of individual computer devices in such a manner as to permit access by authorized individuals.

In a first aspect of the present invention, a method includes receiving a request to present information selected from a plurality of examples of information, reading an identification token of at least one user, and determining whether the at least one user is authorized to be presented the information.

In a second aspect of the present invention, a method (and system and programmable storage medium) includes making a computing application available on a plurality of computing systems, receiving a request to present the application on one of the computing systems, reading an identification token of at least one user of the one of the computing systems, and determining whether the user is authorized to be presented the computing application.

In a third aspect of the present invention, a method (and system and programmable storage medium) includes presenting at least one information example selected from a plurality of examples of information, reading an identification token of at least one user, and determining whether the user is authorized to be presented the at least one information example.

In a fourth aspect of the present invention, a method (and system) includes receiving a request to present information selected from a plurality of examples of information, detecting a presence of a user, attempting to read an identification token of the user, determining whether the user has an identification token that can be read, and selectively suppressing a presentation of the information to any user determined not to have the identification token which can be read.

With the unique and unobvious aspects of the invention, a system, method, and computer program are provided for managing the display of information by a computing system. As such, information (e.g., files, notifications, and applications) can be presented to one or more users on a case-by-case basis for each example of information selectively, without denying access to an entire computing system. Further, the presentation of individual examples of information can be suppressed dynamically based upon the composition of the group of users in the area of the computing system.

Moreover, examples of information (e.g., computer application programs) can be placed in a distributed manner on a multiplicity of individual computer devices in such a manner as to permit access by authorized individuals.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 is a diagram of the environment of the computing system of the present invention;

FIG. 2 is a computing system diagram illustrating the invention;

FIG. 3 is a flow chart for a method 300 of the present invention for the case in which information is currently being displayed on a computing system; and

FIG. 4 is a flow chart of a method 400 of the present invention for the case in which information is requested by a user.

### DETAILED DESCRIPTION OF PREFERRED EMBODIMENTS OF THE INVENTION

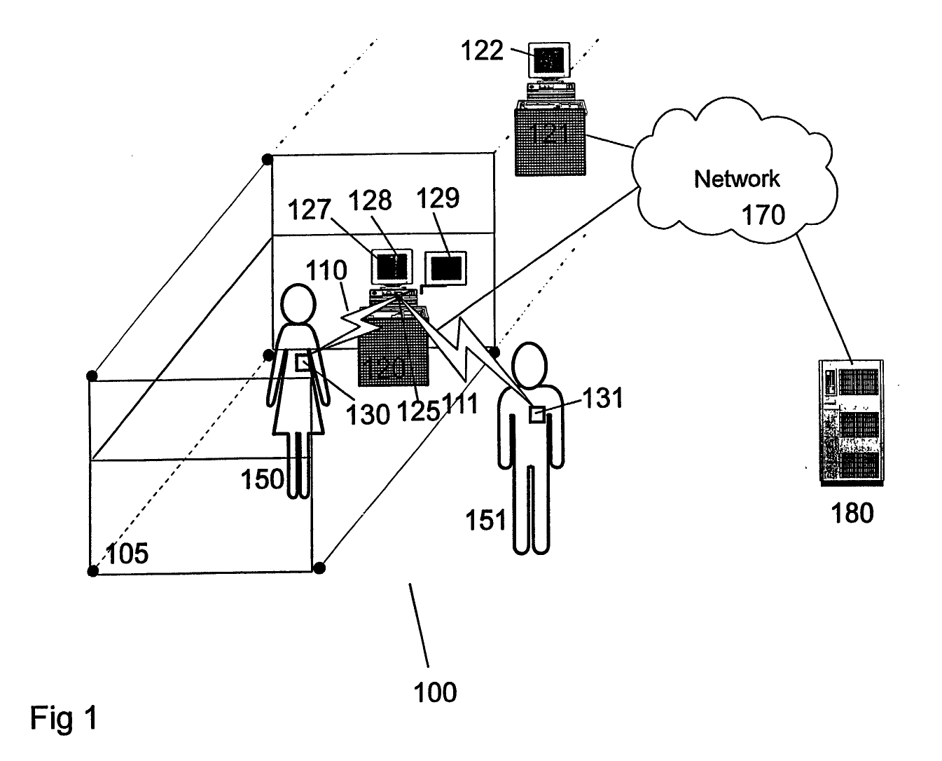

Referring now to the drawings, and more particularly to FIGS. 1-4, there are shown preferred embodiments of the method and structures according to the present invention.

Preferred Embodiment

Referring to FIG. 1, there is shown an environment 100 of the present invention.

The present invention is exemplarily illustrated in an office location 105, but may also be used in a place of residence or a public space. A computing system 120 used in the present invention is an office workstation for which access may be obtained by more than one individual. The workstation which may be a personal computer (PC) such as is manufactured by the IBM Corporation of Armonk, N.Y., or a personal digital assistant (PDA) such as the PalmPilot® manufactured by Palm Inc. of Santa Clara, Calif., which has a user interface 127 associated with it.

The user interface 127 may include several means of information presentation including a visual display, speakers, haptic devices, etc., as well as means for user input including a keyboard, mouse, joystick, trackball, microphone for speech recognition, etc. The user interface 127 may employ one or more display screens 128 and 129. These screens may be in general view of persons in or near the environment. However, one or more may be concealed so as to be viewed only by authorized individuals.

Users 150, 151 of the computing system 120 preferably carry identification (ID) tokens 130, 131 respectively. The identification tokens may be electronic devices such as radio frequency identification (RFID) tags, wireless radio communications devices such as those which may employ the Bluetooth standard or the IEEE 802.11 standard, or active badges such as are manufactured by Ensure Technologies Inc. of Ann Arbor, Mich. Other identification tokens include bar codes which may appear on identification badges, or biometric identification means associated with the individual users such as finger prints or retinal images.

The computing system 120 preferably has a reader 125 associated therewith capable of reading the ID tokens 130, 131 carried by the users. Such a reader 125 may be a radio frequency identification (RFID) reader capable of reading the electronic RFID tokens carried by the users. Such readers 125 are manufactured by Texas Instruments of Dallas, Tex. The reader 125 may be used to read the ID tokens 130 and 131 through wireless communications 110 and 111, respectively.

Additionally, the computing system 120 may be equipped with a motion detector or visual imaging system to detect individuals who are not equipped with ID tokens 130, 131.

The computing system 120, along with other such computing systems 121, etc. may be connected to a network 170. The network 170 may be the Internet, an intranet, a local area network (LAN) or other such network which connects computing devices.

Additionally, a server system 180 containing additional resources may be connected to the network 170.

The users 150 and 151 both may be authorized to use the system 120. However, as is common, user 150 may be authorized to read certain documents presented by the user interface 127. These documents may be text files, audio files, video files, etc. User 150 may also be authorized to receive certain notifications by the system user interface 127 or to use certain applications (e.g., a text processing or imaging processing program) resident on system 120. Such authorization is confirmed when the system, with its attached ID reader 125, reads the ID token 130 carried by user 120.

Hence, when the user 151 approaches the system 120, the ID token 131 is read. If certain information examples (e.g., text, notifications, applications etc.) are displayed, then these information examples may be hidden. If user 151 requests such examples, then the request can be denied. Additionally, a third party (e.g., a security officer, co-worker, manager, etc.) may be notified of the request for unauthorized documents by, for example, a communication sent from system 120 to another system 121.

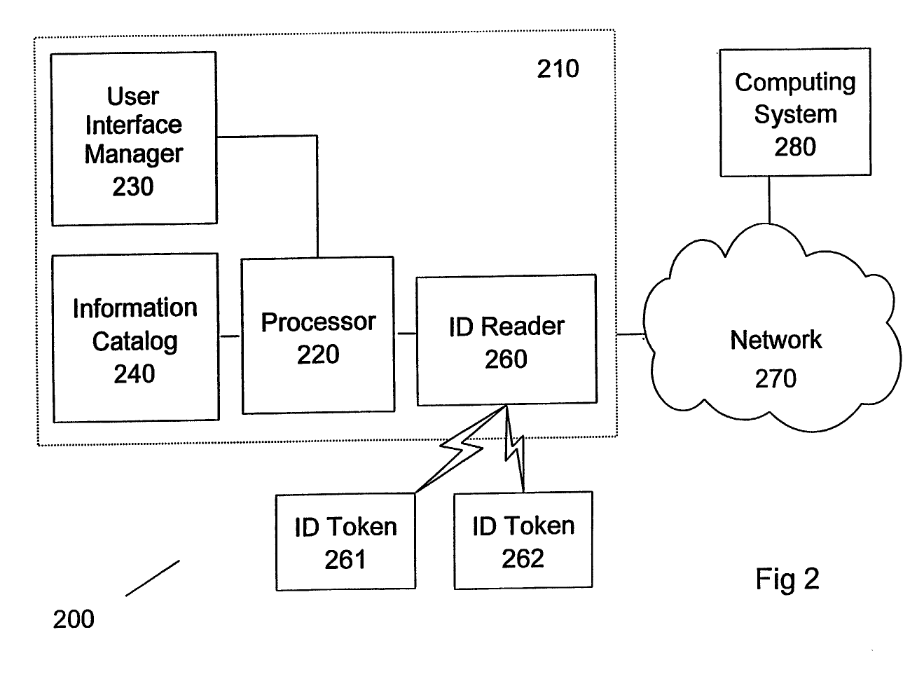

Turning now to FIG. 2, a system 200 is shown of the computing elements used to implement the present invention. A group of elements 210 may be, for example, elements that are active on the computing system 120 of FIG. 1.

In FIG. 2, an ID reader 260 reads the identification information from a multiplicity of tags, 261, 262, etc., and transfers the identification information to a processor 220 (e.g., having a determining unit) of the computing system 210. The reader 260 may periodically update the identification information read from the ID tokens in a dynamic manner. When an ID token is newly read or leaves the area of reading, that information can be transferred automatically to the processor 220.

The system 210 also includes an information catalog 240 which maintains a list of examples of information (e.g., files, notifications, and applications) that may be presented through the user interface 127 of the computing system 120 of FIG. 1.

The catalog 240 maintains a dynamic list of the state of each information example (e.g., whether the information is currently being presented, etc.). Also, associated with each information example in the catalog 240 is a list of authorized users and an ID associated with each user that may be associated with an ID token.

The information catalog 240 contains a list of available information user interface output devices such as personal computer (PC) displays or other user interfaces, personal digital assistant (PDA) displays or other user interfaces, speakers, and others.

Each output device is associated with a reference to its user interface manager and categorized as “private” or “public” depending on how many users can access it. For example, information on a PDA usually can be read only by its owner (e.g., thus being “private”), while information on a large desktop screen can be read by anybody passing by (e.g., thus being “public”). Private output devices are further associated with the user ID of their owner. Other examples of private user interface output devices may be a wireless device such as a cell phone, a laptop PC, or a limited-access display device (e.g., one which is locked in a cabinet for which only authorized users have access, etc.).

For example, if a request is received to present information to the user, (e.g., an e-mail), then the processor 220 queries the information catalog 240 for ID information of users authorized to view this information. Then, the processor 220 counts the number of user IDs currently recognized by the system 210. If multiple users are present, then it queries the information catalog 240 for a private output device that is associated with an authorized user ID. Then, the information may be sent to the user interface manager 230 for presentation on that output device.

For example, information that was previously displayed on monitor 128 (e.g., a public monitor) may be redirected to monitor 129 (e.g., a private monitor), or to the output devices of another computing system 121, as shown in FIG. 1. If only one user is present or if no such output device can be found, then the system behaves as described above.

The processor 220 compares ID information received from the reader 260 with ID information regarding authorized users associated with information examples received from the information catalog 240. If a new ID token is read by the reader 260 while one or more examples of information are being presented by the computing system 210, then the processor 220 determines which examples are authorized to be viewed by the user associated with the ID token. If a request is received to present an additional example of information, then the processor 220 performs a similar analysis.

The processor 220 informs the user interface manager 230 whether an information example that is currently presented (or that is requested) whether the user is authorized to be presented such an example. If the answer is that the user is not authorized for one or more information examples, then the user interface manager 230 may suppress the presentation of those information examples while not suppressing the presentation of information examples that the user is authorized to be presented. Further, the user information manager 230 may present an alternative information example.

It is noted that if a user that is detected (e.g., by a motion or presence detector), but has no readable ID token, then the user is determined to be an unauthorized user.

As an exemplary scenario of the invention, assume that Paul is editing the draft of a patent application in his office. The processor 220 has found that comparison of the ID information taken from Paul's ID token and the list of authorized users for the document shows that Paul is authorized to edit the document. A visitor, Tony, enters Paul's workspace. It is found by the processor 220 that Tony is not authorized to view the draft of the patent application. The processor 220 notifies the user interface manager 230 which suppresses the display of the draft. It is noted that the processor may replace the display of the patent application draft with an empty (e.g., blank) screen, a screen with “sensitive” (confidential) areas missing, or completely suppress the entire screen and display the company lunch menu.

In another example, a computing system in a common area contains various versions of a software application (e.g., IBM's ViaVoice® versions 3.0 and 4.0). Paul is authorized to use version 4.0. The system 210 will respond to his request to present version 4.0 after performing an analysis as described above. Tony is authorized to use version 3.0. Tony, however, requests the presentation of version 4.0 of the application. The system 210 after performing the described analysis does not present version 4.0, but does substitute an allowed version of the same application (e.g., version 3.0).

Additionally, if it is determined that an unauthorized user has attempted to access a currently running program or has requested the presentation of a program, a third party may be notified. The computing system 210 may send a notification to a third party (e.g., to computing system 280) over the network 270. Additionally or alternatively to the third party notification, an audio or visual alarm may sound locally or remotely, to deter the further unauthorized access.

In an additional example, software packages for the example of ViaVoice® 4.0 may be placed on a number of computing systems (e.g., 120, 121, etc. of FIG. 1). Since Paul is a licensed user of version 4.0, he may access the program on any one of the computing systems. Tony, on the other hand, has a license for version 3.0. He can only access the ViaVoice® version 3.0 program on systems that have that program available.

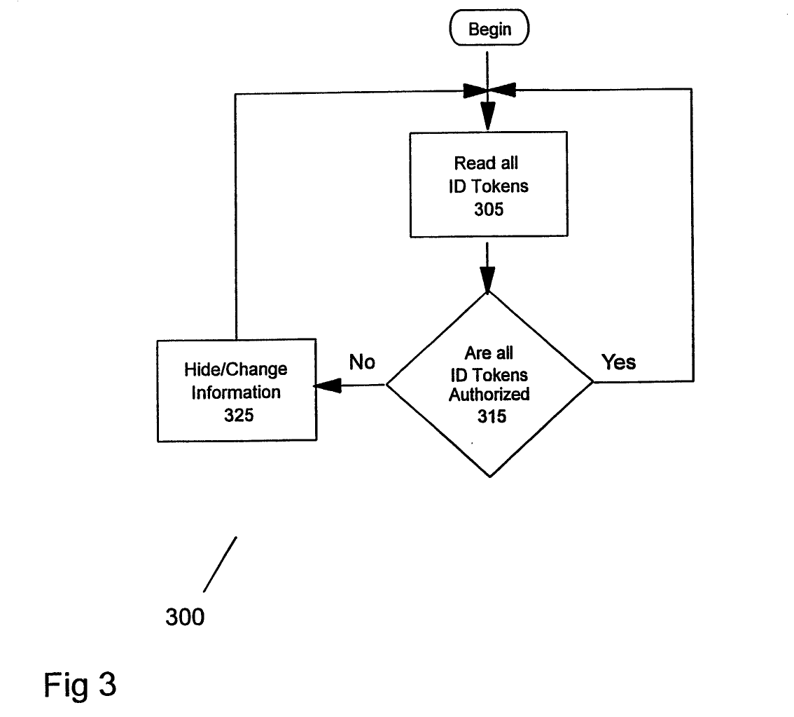

Turning now to FIG. 3, there is a flow chart of a method 300 according to the present invention in the case for which information is currently being displayed.

First, in step 305, the ID tokens for those who have access to the computing system are monitored.

Then in step 315, token IDs are compared with authorized IDS.

If the tokens are found to be associated with authorized users (e.g., a “YES” in step 315), then monitoring of the tokens continues and the process loops to step 305.

If any of the tokens are found not to be authorized for a specific example if information (e.g., a “NO” in step 315), then that information may be hidden or changed in step 325. The change may be to substitute another information example or to send the information to another computing system or to a private user interface output device, as has been explained above. Additionally, notification to a third party may optionally occur.

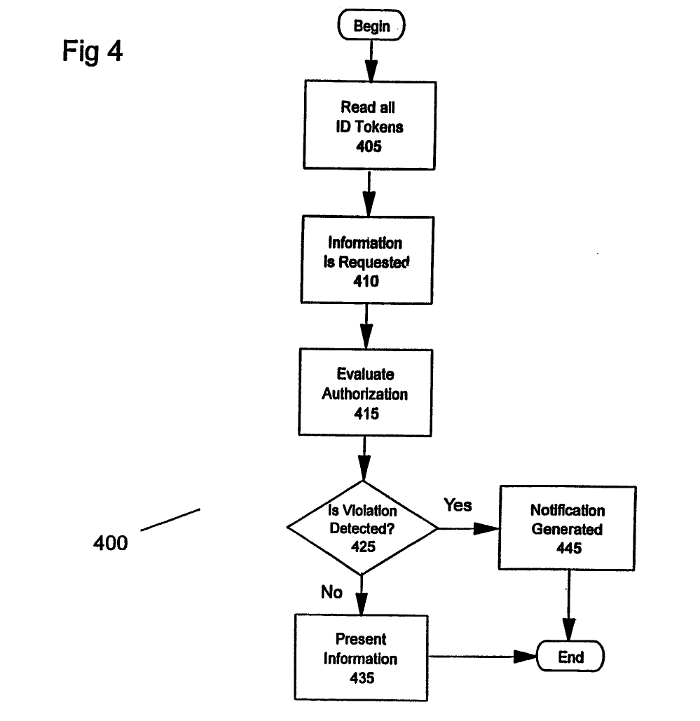

FIG. 4 illustrates the case (e.g., method 400) where a specific example of information is not displayed but is requested.

As in FIG. 3, first in step 405, tokens are monitored. Subsequently, information is requested by a user in step 410.

Then, the request for the information is evaluated in step 415. If the result of the evaluation is that the user is not authorized (e.g., a violation is detected in step 425), then notification to a third party is generated in step 445.

However, if the user is authorized, no violation is detected in step 425 (e.g., a “NO”), and the information is presented to the user in step 435.

Thus, as described above, with the unique and unobvious aspects of the invention, the display of information by a computing system can be reliably and securely managed. Hence, information can be presented to one or more users on a case-by-case basis for each example of information selectively, without denying access to an entire computing system.

Additionally, the presentation of individual examples of information can be suppressed dynamically based upon the composition of the group of users in the area of the computing system. Moreover, examples of information can be placed in a distributed manner on a multiplicity of individual computer devices so as to permit access by authorized individuals.

While the invention has been described in terms of several preferred embodiments, those skilled in the art will recognize that the invention can be practiced with modification within the spirit and scope of the appended claims.

What is claimed is:

1. A method, comprising:
receiving a request to present information selected from a plurality of examples of information;
reading an identification token of at least one user; and
determining whether said user is authorized to be presented said information.

2. The method of claim 1, further comprising:
suppressing a presentation of said information when said user is determined not to be authorized.

3. The method of claim 1, further comprising:
notifying a third party of said request.

4. The method of claim 1, further comprising:
presenting an alternate example of information when said user is determined not to be authorized.

5. The method of claim 3, wherein said third party comprises one of a security officer, a coworker, and a manager.

6. The method of claim 1, wherein said information includes at least one of a text file, an image, a video file, an audio file, a notification, and a computer application.

7. The method of claim 1, wherein said identification token comprises a wireless identification token comprising at least one of a radio frequency identification tag, a wireless radio communications device, a Bluetooth device, an IEEE 802.11 device, and an active badge.

8. The method of claim 1, wherein said identification token comprises at least one of a biometric identification, a fingerprint, a retinal image, and a bar code.

9. A method, comprising:
making a computing application available on a plurality of computing systems;
receiving a request to present said application on one of said computing systems;
reading an identification token of at least one user of said one of said computing systems; and
determining whether said user is authorized to be presented said computing application.

10. The method of claim 9, further comprising:
determining whether said user is licensed to be presented said computing application.

11. The method of claim 9, further comprising:
suppressing a presentation of said application when said user is determined not to be authorized.

12. The method of claim 9, further comprising:
notifying a third party of the request.

13. The method of claim 9, wherein said application comprises one of a text processing program and an image processing program.

14. The method of claim 9, further comprising:
presenting an alternate application when said user is determined not to be authorized.

15. A method, comprising:
presenting at least one information example selected from a plurality of examples of information,
reading an identification token of at least one user; and
determining whether said user is authorized to be presented said at least one information example.

16. The method of claim 15, further comprising:
terminating the presentation of said information example when said user is determined not to be authorized.

17. The method of claim 15, further comprising:
notifying a third party of the reading of said identification token.

18. The method of claim 16, further comprising:
presenting an alternate example of information when said user is determined not to be authorized.

19. The method of claim 15, further comprising:
presenting said information example on an alternate user interface device.

20. The method of claim 19, wherein said alternate information device comprises one of a personal digital assistant (PDA), a portable personal computer, a wireless device, a cellular phone, and a limited-access display.

21. A method, comprising:
receiving a request to present information selected from a plurality of examples of information;
reading identification tokens from a plurality of users;
determining whether any of said users are not authorized to be presented said information; and
selectively suppressing a presentation of said information to said any of said users determined not to be authorized.

22. The method of claim 21, further comprising:
notifying a third party of said request.

23. The method of claim 21, further comprising:
presenting an alternate example of information when said user is determined not to be authorized.

24. The method of claim 22, wherein said third party comprises one of a security officer, a coworker, and a manager.

25. The method of claim 21, wherein said information includes at least one of a text file, an image, a video file, an audio file, a notification, and a computer application.

26. The method of claim 21, wherein said identification token comprises a wireless identification token comprising at least one of a radio frequency identification tag, a wireless radio communications device, a Bluetooth device, an IEEE 802.11 device, and an active badge.

27. The method of claim 21, wherein said identification token comprises at least one of a biometric identification, a fingerprint, a retinal image, and a bar code.

28. A method, comprising:
receiving a request to present information selected from a plurality of examples of information;
detecting a presence of a user;
determining whether said user has an identification token that can be read; and
selectively suppressing a presentation of said information to any said user determined not to have said identification token which can be read.

29. The method of claim 28, further comprising:
after said detecting, attempting to read an identification token of said user.

30. A system, comprising:
a processor for receiving a request to present information selected from a plurality of examples of information;
a reader, coupled to said processor, for reading an identification token of at least one user; and
a determining unit for determining whether said user is authorized to be presented said information.

31. The system of claim 30, wherein said processor selectively suppresses a presentation of said information when said user is determined not to be authorized.

32. The system of claim 30, further comprising:
a notification unit for notifying a third party of said request.

33. The system of claim 30, wherein said processor presents an alternate example of information when said user is determined not to be authorized.

34. The system of claim 32, wherein said third party comprises one of a security officer, a coworker, and a manager.

35. The system of claim 30, wherein said information includes at least one of a text file, an image, a video file, an audio file, a notification, and a computer application.

36. The system of claim 30, wherein said identification token comprises a wireless identification token comprising at least one of a radio frequency identification tag, a wireless radio communications device, a Bluetooth device, an IEEE 802.11 device, and an active badge.

37. The system of claim 30, wherein said identification token comprises at least one of a biometric identification, a fingerprint, a retinal image, and a bar code.

38. A system, comprising:
a processor for receiving a request to present an application on one of a plurality of computing systems, said computing application being available on said plurality of computing systems;
a reader for reading an identification token of at least one user of said one of said computing systems; and
a determining unit for determining whether said user is authorized to be presented said computing application.

39. A system, comprising:
a display for presenting at least one information example selected from a plurality of examples of information;
a reader for reading an identification token of at least one user; and
a determining unit for determining whether said user is authorized to be presented said at least one information example.

40. A system, comprising:
a processor for receiving a request to present information selected from a plurality of examples of information;
a reader for reading identification tokens from a plurality of users; and
a determining unit for determining whether any of said users are not authorized to be presented said information,
said processor selectively suppressing a presentation of said information to said any of said users determined not to be authorized.

41. A system, comprising:
a processor receiving a request to present information selected from a plurality of examples of information;
a detector for detecting a presence of a user; and
a determining unit for determining whether said user has an identification token that can be read,
said processor selectively suppressing a presentation of said information to any said user determined not to have said identification token which can be read.

42. The system of claim 41, further comprising:
a reader for attempting to read an identification token of said user;

43. A signal bearing medium tangibly embodying a program of machine-readable instructions executable by a digital processing apparatus to perform a method, said method comprising:
receiving a request to present information selected from a plurality of examples of information;
reading an identification token of at least one user; and
determining whether said user is authorized to be presented said information.

44. A signal bearing medium tangibly embodying a program of machine-readable instructions executable by a digital processing apparatus to perform a method, said method comprising:
making a computing application available on a plurality of computing systems;
receiving a request to present said application on one of said computing systems;
reading an identification token of at least one user of said one of said computing systems; and
determining whether said user is authorized to be presented said computing application.

45. A signal bearing medium tangibly embodying a program of machine-readable instructions executable by a digital processing apparatus to perform a method, said method comprising:
presenting at least one information example selected from a plurality of examples of information;
reading an identification token of at least one user; and
determining whether said user is authorized to be presented said at least one information example.

46. A signal bearing medium tangibly embodying a program of machine-readable instructions executable by a digital processing apparatus to perform a method, said method comprising:
receiving a request to present information selected from a plurality of examples of information;
reading identification tokens from a plurality of users;
determining whether any of said users are not authorized to be presented said information; and
selectively suppressing a presentation of said information to said any of said users determined not to be authorized.

47. A signal bearing medium tangibly embodying a program of machine-readable instructions executable by a digital processing apparatus to perform a method, said method comprising:
receiving a request to present information selected from a plurality of examples of information;
detecting a presence of a user;
determining whether said user has an identification token that can be read; and
selectively suppressing a presentation of said information to any said user determined not to have said identification token which can be read.

48. The signal-bearing medium of claim 47, wherein said method further comprises:
attempting to read an identification token of said user.
